(19) United States
(12) Patent Application Publication
(10) Pub. No.: US 2021/0131336 A1
(43) Pub. Date: May 6, 2021

(54) SYSTEMS, APPARATUS, AND METHODS FOR INCREASING COMBUSTION TEMPERATURE OF FUEL-AIR MIXTURES IN INTERNAL COMBUSTION ENGINES

(71) Applicant: Radical Combustion Technologies, LLC, Vienna, VA (US)

(72) Inventors: Randall R. RAYMER, Kingwood, TX (US); Michael J. MANFREDI, Vienna, VA (US)

(21) Appl. No.: 17/146,127

(22) Filed: Jan. 11, 2021

Related U.S. Application Data
(63) Continuation of application No. PCT/US2019/041646, filed on Jul. 12, 2019.
(60) Provisional application No. 62/697,178, filed on Jul. 12, 2018.

(51) Int. Cl. F02B 19/10; F02F 1/24; F02F 3/12; F02M 31/02; F02B 19/12; F02B 19/18; F02F 3/16; F02F 1/36; F01P 7/14; F01P 3/00; F01P 3/02; F01P 3/06; F02F 1/16; F01N 13/10; F02M 35/10; F02M 25/028; F02C 7/12

(52) U.S. Cl. CPC F02B 19/1019; F05D 2260/20; F02F 3/12; F02M 31/02; F02B 19/12; F02B 19/18; F02F 3/16; F02F 1/36; F01P 7/14; F01P 3/00; F01P 3/02; F01P 3/06; F02F 1/16; F01N 13/10; F02M 35/10222; F02M 25/028; F02C 7/12; F01P 2007/146; F01P 2003/006; F01P 2003/001; F05D 2220/32; F02F 1/242

(57) ABSTRACT

Systems, apparatus, and methods described herein can overcome some of the disadvantages associated with existing internal combustion engines. In particular, systems, apparatus, and methods described herein relate to improving the combustion process of internal combustion engines through insert technologies, engine modifications, control technologies, and/or other methodologies.

### CROSS-REFERENCE TO RELATED APPLICATIONS

This application is a continuation of International Application No. PCT/US2019/041646, filed Jul. 12, 2019, titled “SYSTEMS, APPARATUS, AND METHODS FOR INCREASING COMBUSTION TEMPERATURE OF FUEL-AIR MIXTURES IN INTERNAL COMBUSTION ENGINES,” which claims priority to and the benefit of U.S. Provisional Patent Application No. 62/697,178, filed Jul. 12, 2018, titled “SYSTEMS, APPARATUS, AND METHODS FOR INCREASING COMBUSTION TEMPERATURE OF FUEL-AIR MIXTURES IN INTERNAL COMBUSTION ENGINES,” the disclosure of each of which is incorporated herein by reference.

### TECHNICAL FIELD

The present disclosure relates generally to systems, apparatus, and methods for improving combustion of internal combustion engines. More specifically, the present disclosure relates to increasing combustion temperature of fuel-air charges in chambers of internal combustion engines to induce robust Enhanced Radical Ignition (“ERI”), which can involve, for example, the generation and control of Radical Ignition (“RI”) species and/or the use of a Regenerative Heat-Retaining Element (“RHRE”).

### BACKGROUND

Existing natural-gas burning, reciprocating piston, internal combustion engines, i.e., “legacy” engines, suffer from certain disadvantages. For example, such legacy engines have: lower combustion stability, higher pollutant emissions (e.g., nitrogen oxide (NOx) and carbon dioxide (CO₂) emissions), greater fuel consumption, etc. Therefore, there is a need for improved engine design to achieve higher stability, lower emissions, and/or higher fuel efficiency.

### SUMMARY

Systems, apparatus, and methods described herein can overcome some of the disadvantages associated with existing internal combustion engines. In particular, systems, apparatus, and methods described herein relate to improving the combustion process of internal combustion engines through insert technologies, engine modifications, control technologies, and/or other methodologies.

### BRIEF DESCRIPTION OF THE DRAWINGS

The skilled artisan will understand that the drawings primarily are for illustrative purposes and are not intended to limit the scope of the inventive subject matter described herein. The drawings are not necessarily to scale; in some instances, various aspects of the inventive subject matter disclosed herein may be shown exaggerated or enlarged in the drawings to facilitate an understanding of different features. In the drawings, like reference characters generally refer to like features (e.g., functionally similar and/or structurally similar elements).

FIG. 1 is a schematic diagram of a section of an example reciprocating-piston, internal combustion engine, according to embodiments described herein.

FIG. 2 is a schematic diagram of a section of an example reciprocating-piston, internal combustion engine, according to embodiments described herein.

FIG. 3 is a schematic diagram of an example reciprocating-piston, internal combustion engine, connected to a turbocharger unit, according to embodiments described herein.

FIG. 4 is a schematic diagram of an example vapor-phase cooling system, used with an internal combustion engine, according to embodiments described herein.

### DETAILED DESCRIPTION

Systems, apparatus, and methods are described herein for improving performance of internal combustion engines. Such systems, apparatus, and methods can improve performance using insert technologies, engine modifications, and/or control technologies, as further described herein.

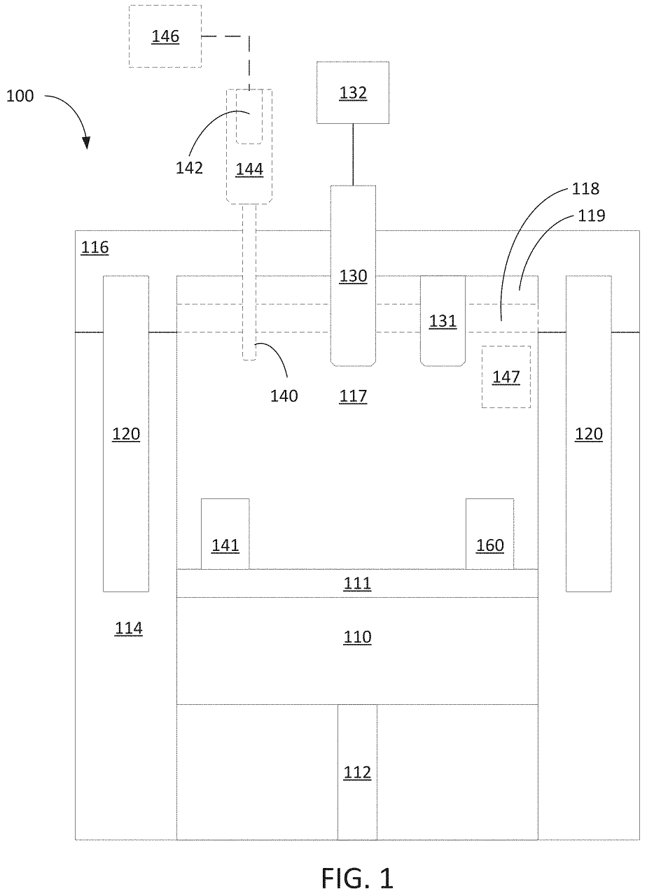

FIG. 1 is a schematic illustration of a section of an example internal combustion engine 100. The engine 100 can be, for example, a fluid-cooled, direct-injected, natural gas-fueled, lean-burning, engine. The engine 100 includes a main combustion chamber 117, a reciprocating piston 110, a head 116, a cylinder 114, a fuel injector 130, a spark igniter 131, at least one air inlet 141, and at least one air outlet 160. The engine 100 can include additional cylinders (such as cylinder 114), chambers (such as chamber 117), pistons (such as piston 110), and/or other components similar to those depicted in FIG. 1.

Chamber 117 can be defined by cylinder 114, head 116, and piston 110. Air can be supplied to chamber 117 via air inlet 141, and exhaust can be discharged from chamber 117 via exhaust outlet 160. Fuel from a fuel source 132 can be supplied to chamber 117 via fuel injector and igniter 130.

Reciprocating piston 110 can be configured to reciprocate in cylinder 114. Reciprocating piston 110 can be driven by a crankshaft (not depicted) coupled to a rod 112. Reciprocating piston 110 can have a crown 111. Reciprocating piston 110 can be cooled by engine oil being diverted into an internal region of the piston 110, and the crown 111 can be cooled from the oil circulation being fed to piston 110. Such cooling can be controlled via engine design, e.g., by adjusting the dimensions of orifices or passageways (and/or installing new orifices) for circulating the engine oil. Accordingly, the temperature of the piston crown 111 can be controlled by adjusting the flow of engine oil. Depending on the adjustments to the flow of the engine oil, additional design changes may also be needed to the piston skirt (and/or other components of the engine), to increase longevity of components by providing proper clearances for the adjustments that are made.

To adjust retention of heat within main combustion chamber 117 and/or enhance other performance of the engine, different designs of crown 111 can also be used. For example, a thickness or density of crown 111 can be increased to increase heat retention within chamber 117. Alternatively or additionally, piston 110 or crown 111, or a portion of such components or other components of the engine 100 (e.g., the cylinder 114), can be formed of a material or combination of materials that can act as a thermal barrier to reduce temperature migration into and/or through piston 110 or crown 111. A variety of suitable materials can be used, including, for example, metal and/or ceramic materials (e.g., Yttria-stabilized Zirconium Oxide or Zirconia thermal spray powders). The material or combination of materials can be selected based on their thermal properties to match a specific engine configuration and/or design requirement. In some embodiments, the material can be applied as a spray-on coating, such that existing engines (e.g., engine 100) can be sprayed with suitable material to increase heat retention within the main chamber (e.g., chamber 117). The spray-on coating can be applied using various spraying techniques, including for example, thermal spraying such as flame, plasma, and/or detonation. In some embodiments, the engine 100 can have a two or three piece piston design, and can allow for different crown designs and change out due to combustion damage or for performance enhancements.

Head 116 can be fluid-cooled (e.g., via liquid, vapor, and/or air), with a coolant that runs through passages 120 in head 116 and cylinder 114. To adjust temperatures within engine 100, the fluid flow and cooling to the head 116 can also be controlled. For example, fluid flow can be restricted to reduce cooling of the head 116. Engine 100 can include automated components (e.g., temperature control valves, pressure control valves, thermostat controls, etc.) that use a “Control Oil IN/Control Water OUT” scheme that controls the temperature of the oil in and the water out, e.g., oil-in temperature can be controlled to approximately 140 degrees Fahrenheit and water-out temperature can be controlled to 10 degrees greater than oil-out temperature. These temperatures can be changed, taking into account various limitations (e.g. operating limits of various components), to raise the temperatures of engine 100. In some embodiments, orifices, valves, and/or other components can be installed and/or the dimensions of orifices, passageways, etc. can be adjusted to also control the temperature of engine 100. For example, by installing an orifice or a separate thermostat-controlled water control valve, individual head temperatures can be controlled to specific values.

In some embodiments, a processor can be configured to adjust the temperatures within engine 100. The processor can be configured to control fluid flow to the piston 110 and/or head 116 (e.g., oil or water flow to the piston 110, or water flow to the head 116) by changing a diameter of one or more passageways delivering the fluid, changing a flow rate setting of the fluid, changing a temperature setting of the fluid, etc. In some embodiments, the processor can be configured to receive one or more user inputs, and to adjust the flow of fluid to the piston 110 and/or head based on the user inputs. In some embodiments, the processor can receive information from one or more sensors (e.g., thermostats), monitor that information for changes and/or specific events, and control one or more components of the engine 100 (e.g., valves, channels, etc.). For example, the processor can be operatively coupled to one or more sensor-controlled valves (e.g., thermostat-controlled valves) that open and close based on set sensor values (e.g., set temperature values), which can be controlled and/or modified via the processor. The processor can be any type of suitable processor that can control the operation of one or more components of engine 100. In some embodiments, the processor can be a general purpose processor, a microprocessor, a Field Programmable Gate Array (FPGA), an Application Specific Integrated Circuit (ASIC), a Digital Signal Processor (DSP), and/or the like. As a specific example, the processor in an automobile can include one or more electronic control units that are coupled to one or more components of the automobile (e.g., including an engine and/or sensors) via a communication network (e.g., a Controller Area Network or CAN bus).

In some embodiments, head 116 can be redesigned to retain heat within chamber 117. For example, similar to piston 110 and crown 111, a portion or all of head 116 can be formed of a material or combination of materials (or sprayed with such materials) to reduce temperature migration into and/or through head 116. Additionally or alternatively, a shape, dimension, or other configuration of head 116 can be adjusted to increase heat retention within chamber 117. Redesigning the head 116 to either restrict water flow and/or to change the configuration of the combustion chamber 117 can facilitate less temperature absorption by the head 116, which in turn can raise the temperature within portions of the combustion chamber 117 and result in higher compression temperature at ignition.

Optionally, in some embodiments, the engine 100 can include a RHRE 118. RHRE 118 can be implemented as a regenerative heat retainer, such as those described in U.S. Pat. No. 9,567,939, titled “Thermally stratified regenerative combustion chamber, issued Feb. 14, 2017, and U.S. Pat. No. 9,567,896, titled “Method for modifying combustion chamber in a reciprocating piston internal combustion engine and resulting engine,” issued Feb. 14, 2017, the disclosures of each of which are incorporated herein by reference. RHRE 118 can be coupled to and/or configured to be coupled to the head 116. RHRE 118 can have a shape that substantially corresponds to a shape of a portion of the chamber 117 defined by the head 116 with a clearance gap 119 between the RHRE 118 and the head 116. RHRE 118 can expand and contract as a function of the operating temperature of the engine 100, thereby changing the size of gap 119. When RHRE 118 expands to fill the distance of gap 119 and comes into contact with head 116, RHRE 118 can be cooled via the fluid-cooled head 116. RHRE 118 can subsequently contract and gap 119 can form again. RHRE 118 can be formed of materials and/or designed to have dimensions that allow for further control of engine operating temperatures, as further disclosed in U.S. Pat. Nos. 9,567,939 and 9,567,896.

For ignition of the mixture of air and fuel within chamber 117, a spark igniter 131 can be used. Additionally or alternatively, a precombustion chamber (“PCC”) igniter 142 can be used, with a PCC 144 into which a mixture of air and fuel precombustion charge 146 can be supplied. The PPC igniter 142 can ignite the precombustion charge 146 in timed relationship with an intended combustion of the charge in the main combustion chamber 117 and supply the ignited precombustion charge 146 into the chamber 117 via an outlet 140. The ignited precombustion charge 146 includes partially combusted radicals of fuel, which can be used to ignite the mixture of air and fuel within the chamber 117. The spark igniter 131 and/or the PCC igniter 142 can be used to ignite the charge in the chamber 117, for example, during start-up of a cold engine and/or other conditions requiring additional ignition or combustion enhancement.

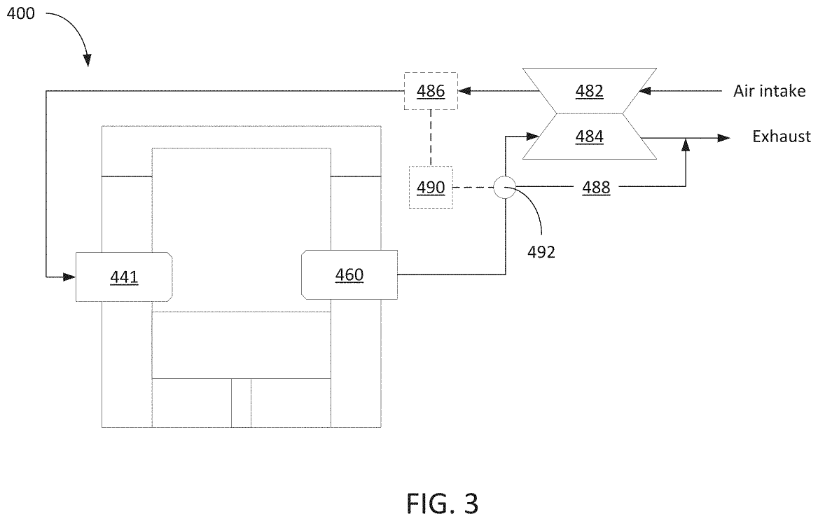

Engine 100 can have a specific geometric compression ratio, i.e., a ratio of a volume of cylinder 114 to a volume of combustion chamber 117 under a full stroke of the piston 110 (e.g., a movement from top dead center (“TDC”) to bottom dead center (“BDC”)). Engine 100 can have different dynamic compression ratios that vary depending on the position of the piston 110 at intake valve closing. In some embodiments, when engine 100 includes a turbocharger system that provides a pressure or temperature increase or boost, the compression ratio may be lessened or decreased to compensate for elevated compression (e.g., resulting from increased pressure and/or temperature) and to control detonation. Further details of an engine including a turbocharger system are provided with respect to FIG. 3, described below.

In some embodiments, engine 100 can optionally have a heating element 147, such as, for example, a glow plug, that is disposed within the combustion chamber 117 and can be used to heat the engine 100 to cause ignition. In some embodiments, one or more additional heating elements can be provided in other locations of engine 100, e.g., PCC 144.

In some embodiments, temperatures within engine 100 can also be increased by pre-heating the fuel gas that is delivered into chamber 117 and/or using a hybrid gas mixture (e.g. compressed natural gas (CNG), methane-hydrogen, methane-propane, etc.). In some embodiments, intake air can be pre-heated, e.g., via a high-pressure-ratio turbocharger system, regenerative burners (e.g., using steam exhaust gas heat recovery, exhaust gas recirculation, internal or external heat sources), advance ignition timing, and/or other suitable methodologies.

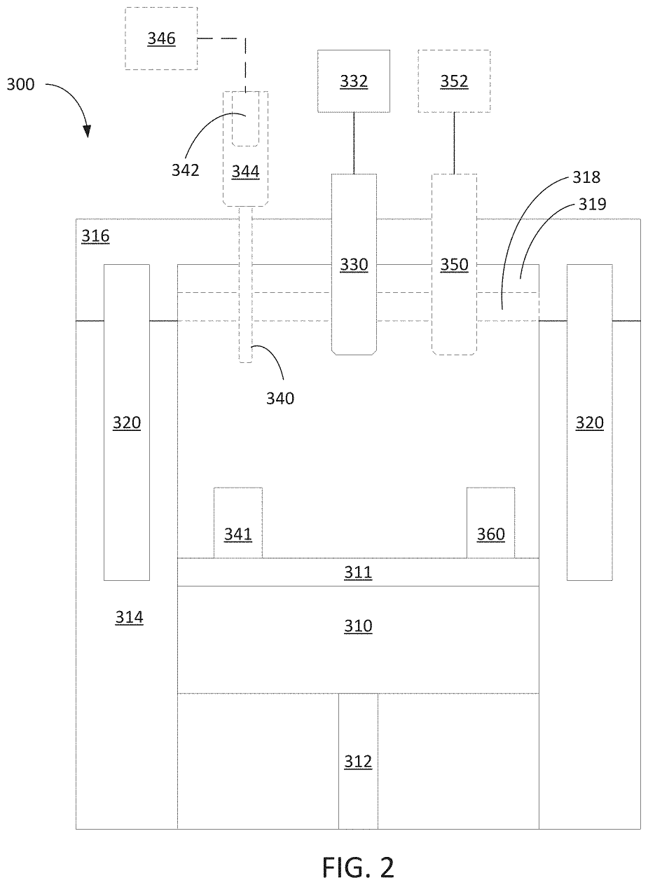

Referring now to FIG. 2, a schematic illustration of a section of an example internal combustion engine 300 is shown. Engine 300 can include components that are similar to engine 100. For example, engine 300 can include a reciprocating piston 310 with a crown 311, a rod 312 with one or more ports, an air inlet 341 with one or more ports, an exhaust outlet 360, a cylinder 314, one or more coolant passages 320, a head 316, and a fuel injector 330 that can deliver fuel form a fuel source 332 into a chamber of engine 300. Optionally, engine 300 can also include a RHRE 318 spaced from the head 316 by a gap 319, a PCC 344 that can receive an air/fuel mixture 346, a PCC igniter 342, and an outlet 340.

Engine 300 can be a dual-fuel engine. In some embodiments, engine 300 can include a second fuel injector 350 that can deliver a second type of fuel from a fuel source 352 into the chamber of engine 300. This second type of fuel can be different from the fuel delivered by fuel injector 330. For example, fuel injector 330 can deliver natural gas, while fuel injector 350 can deliver diesel fuel. Alternatively or additionally, in some embodiments, PCC 344 can receive an air/fuel mixture 346 that includes a type of fuel (e.g., diesel) that is different from the fuel received from fuel sources 332 and/or 352. The compression ratio of engine 300 can be adjusted to accommodate the ignition and/or dispersion of additional type(s) and/or amount(s) of fuel, including, for example, a diesel pilot fuel.

FIG. 3 schematically depicts an example internal combustion engine 400. Engine 400 can be similar to any of the other engines described herein (e.g., engines 100 and/or 300) and include similar components such as, for example, a cylinder, head, reciprocating piston, main combustion chamber, RHRE, fuel injector, air inlet(s), exhaust outlet(s), etc.

Specifically, engine 400 includes a turbocharger system having a turbine 484 and a compressor 482. Exhaust gases exiting engine 400 from exhaust outlet 460 can be used to spin the turbine 484 of the turbocharger system, which can power the compressor 482 to draw in intake air, compress and heat it, and send it onto the engine 400 (e.g. to be received into the chamber via an air inlet 441). Engine 400 can optionally include an air cooler 486 that cools the intake air discharged from the compressor 482, a valve or juncture 492 that can direct a portion of the exhaust gases through a bypass channel 488 that can bypass the turbocharger turbine 484, and/or other components that allow for tuning and/or control of the turbocharger system. Optionally, engine 400 can also include and/or be coupled to a control unit 490 (e.g., a processor) that can control the activation and/or operation of the cooler 486, valve 492, and/or other components of engine 400. Control unit 490 can be configured to control these other components of engine 400 to tune the turbocharger system to obtain a precise boost for elevating the pressure and temperature of the gases within the main combustion chamber of the engine 400, such that an adequate temperature increase is achieved for ignition. Control unit 490 (or another suitable component) can be configured to perform such tuning in real-time or near real-time (e.g., within a few seconds of receiving information and/or a user input) based on sensor readings and/or user inputs into engine 400.

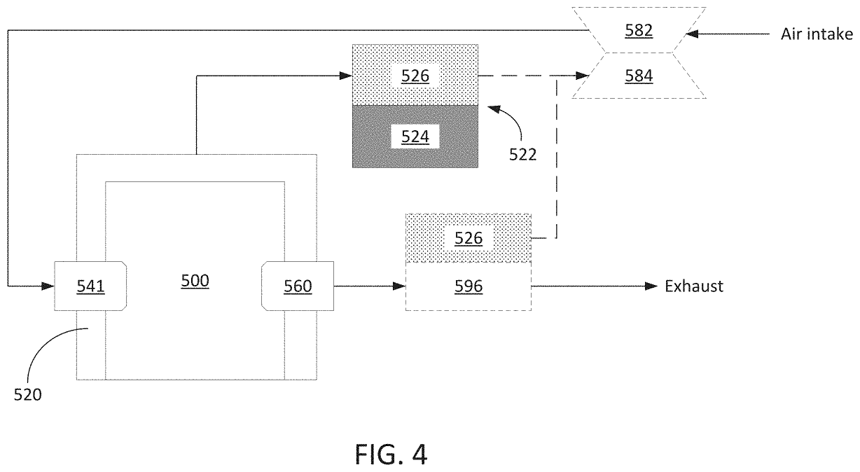

FIG. 4 schematically depicts an example internal combustion engine 500 that can utilize vapor-phase cooling technology. Engine 500 can take advantage of the heat transfer rates that occur with a liquid-to-vapor phase change during boiling. Engine 500 can be similar to any of the other engines described herein (e.g., engines 100, 300, and/or 400) and include similar components such as, for example, a cylinder, head, reciprocating piston, main combustion chamber, RHRE, fuel injector, air inlet(s), exhaust outlet(s), etc.

In some embodiments, engine 500 can be a Rankine Compression Gas turbine (RCG) engine that makes use of vapor-phase cooling technology. For example, engine 500 can include components for generating steam and/or vapor. Engine 500 can include a cooling system that circulates water (or another suitable coolant) through coolant jacket(s) or passage(s) 520 disposed within and/or around an engine cylinder and/or head of engine 500. When the water within coolant passages 520 becomes heated due to the operation of engine 500 (e.g., ignition of gases within the main combustion chamber), the water can boil off and become steam/vapor. The liquid 524 and vapor 526 of the water can be separated in a separator tank 522. Optionally, a portion of the vapor 526 can be circulated to a turbine 584, which can be coupled to a compressor 582. Engine 500 can also include a steam generator 596 that receives exhaust gases from exhaust outlet 560, and use the heat from the exhaust gases to generate steam/vapor 526, which can also be circulated to the turbine 584 (or a different turbine, e.g., used to drive the intake of a different mixture of air/gas) and used to power the compressor 582 (or a different compressor).

Compressor 582 can be similar to compressor 482, e.g., compressor 582 can form a part of a turbocharger system. As depicted in FIG. 4, when compressor 582 spins in response to the spinning of turbine 582, compressor 582 can draw in intake air, heat it, and pass it onto engine 500 (e.g. to be received into the chamber via an air inlet 541).

Vapors 524 or 526, after passing through turbine 582 and/or coming directly from separator tank 522 or steam generator 596 can be returned to a liquid state via a condenser (not depicted). The resulting liquid can then be re-circulated into the various components of engine 500, such as, for example, the cooling system (including cooling passages 520) and/or steam generator 596.

In some embodiments, a control unit (not depicted) can be used with the engine 500 and/or components of the vapor phase cooling technology, e.g., to control circulation of water, engine temperatures, amount of vapor being directed to a turbine, etc.

While various embodiments have been described and illustrated herein, those of ordinary skill in the art will readily envision a variety of other means and/or structures for performing the function and/or obtaining the results and/or one or more of the advantages described herein, and each of such variations and/or modifications is deemed to be within the scope of the embodiments described herein. More generally, those skilled in the art will readily appreciate that all parameters, dimensions, materials, and configurations described herein are meant to be exemplary and that the actual parameters, dimensions, materials, and/or configurations will depend upon the specific application or applications for which the inventive teachings is/are used. Those skilled in the art will recognize, or be able to ascertain using no more than routine experimentation, many equivalents to the specific inventive embodiments described herein. It is, therefore, to be understood that the foregoing embodiments are presented by way of example only and that, within the scope of the appended claims and equivalents thereto; embodiments may be practiced otherwise than as specifically described and claimed. Embodiments of the present disclosure are directed to each individual feature, system, article, material, kit, and/or method described herein. In addition, any combination of two or more such features, systems, articles, materials, kits, and/or methods, if such features, systems, articles, materials, kits, and/or methods are not mutually inconsistent, is included within the inventive scope of the present disclosure.

Also, various concepts may be embodied as one or more methods. The acts performed as part of the methods may be ordered in any suitable way. Accordingly, embodiments may be constructed in which acts are performed in an order different than described, which may include performing some acts simultaneously, even though shown as sequential acts in illustrative embodiments.

1. An apparatus, comprising:
a head;
a cylinder coupled to the head and defining a channel;
a piston disposable within the channel and configured to reciprocate along a length of the channel during a plurality of combustion cycles, the piston including a crown that forms a seal against an inner surface of the cylinder;
a main combustion chamber collectively bounded by the head, the cylinder, and the crown;
an air intake configured to deliver air into the main combustion chamber during each combustion cycle from the plurality of combustion cycles;
a fuel intake configured to deliver fuel into the main combustion chamber during each combustion cycle from the plurality of combustion cycles, such that the fuel mixes with the air to produce a main charge of air and fuel that can be ignited during each combustion cycle from the plurality of combustion cycles; and
a coating disposable on the crown and a portion of the head facing an interior of the main combustion chamber, the coating configured to increase heat retention within the main combustion chamber such that heat generated by igniting the main charge during each combustion cycle from the plurality of combustion cycles can be retained for heating the main charge during a subsequent combustion cycle from the plurality of combustion cycles.

2. The apparatus of claim 1, further comprising:
a precombustion chamber configured to receive a precombustion charge of air and fuel;
a precombustion ignitor configured to ignite the precombustion charge; and
an outlet configured to deliver the precombustion charge after being ignited to the main combustion chamber such that the precombustion charge can ignite the main charge.

3. The apparatus of claim 1, wherein the coating is further disposable on the inner surface of the cylinder to further increase heat retention within the main combustion chamber.

4. The apparatus of claim 1, wherein the coating includes a combination of a metal and a ceramic compound.

5. The apparatus of claim 1, wherein the crown is formed of a high density material such that the crown is configured to increase heat retention within the main combustion chamber.

6. The apparatus of claim 1, further comprising a regenerative burner configured to heat the air prior to the air being delivered by the air intake into the main combustion chamber.

7. The apparatus of claim 1, further comprising a glow plug disposed within the main combustion chamber and configured to heat the main charge during one or more combustion cycles from the plurality of combustion cycles.

8. The apparatus of claim 1, further comprising a turbocharger configured to increase an amount of the air delivered into the main combustion chamber, thereby increasing at least one of a heat or a pressure of the air.

9. The apparatus of claim 1, wherein the fuel intake is a first fuel intake and the fuel is a first type of fuel, the apparatus further comprising a second fuel intake configured to deliver a second type of fuel into the main combustion chamber during each combustion cycle from the plurality of combustion cycles, such that the main charge further includes the second type of fuel.

10. A system, comprising:
an engine including:
a head;
a cylinder coupled to the head and defining a channel;
a piston disposable within the channel and configured to reciprocate along a length of the channel during a plurality of combustion cycles, the piston including a crown that forms a seal against an inner surface of the cylinder; and
a main combustion chamber collectively bounded by the head, the cylinder, and the crown;
a first cooling mechanism configured to deliver a first fluid to cool the crown during the plurality of combustion cycles;
a second cooling mechanism configured to deliver a second fluid to cool the head during the plurality of combustion cycles;
a set of sensors configured to measure information associated with at least one of the first fluid or the second fluid; and
a processor operatively coupled to the engine, the first cooling mechanism, the second cooling mechanism, and the set of sensors, the processor configured to:
receive information from the set of sensors; and
control, based on the information, at least one of the first cooling mechanism or the second cooling mechanism to change a flow of at least one of the first fluid or the second fluid being delivered.

11. The system of claim 10, wherein the first cooling mechanism includes a set of fluid passageways located in the piston and at least one valve disposed in at least one of the set of fluid passageways,
the processor configured to control the at least one of the first cooling mechanism or the second cooling mechanism by closing or opening the at least one valve.

12. The system of claim 10, wherein the first fluid is engine oil and the second fluid is water.

13. The system of claim 10, wherein the processor is further configured to:
in response to receiving a user input, change a temperature setting associated with at least one of the first fluid or the second fluid,
the processor configured to control at least one of the first cooling mechanism or the second cooling mechanism based on the change to the temperature setting.

14. The system of claim 13, wherein the temperature setting is at least one of: a temperature of the first fluid flowing to the head, a temperature of the first fluid flowing out from the head, a temperature of the second fluid flowing to the crown, or a temperature of the second fluid flowing out from the crown.

15. A system, comprising:
an engine including:
a head;
a cylinder coupled to the head and defining a channel;
a piston disposable within the channel and configured to reciprocate along a length of the channel during a plurality of combustion cycles, the piston including a crown that forms a seal against an inner surface of the cylinder;
a main combustion chamber collectively bounded by the head, the cylinder, and the crown;
an air intake configured to deliver air into the main combustion chamber during each combustion cycle from the plurality of combustion cycles;
a fuel intake configured to deliver fuel into the main combustion chamber during each combustion cycle from the plurality of combustion cycles, such that the fuel mixes with the air to produce a main charge of air and fuel that is combusted during each combustion cycle from the plurality of combustion cycles; and
an exhaust outlet configured to receive exhaust gases from the main combustion chamber after the main charge is combusted; and
a vapor device configured to receive heat generated by the engine during the plurality of combustion cycles and to generate vapor in response to receiving the heat.

16. The system of claim 15, wherein the engine is a Rankine compression gas turbine engine.

17. The system of claim 15, wherein the vapor device includes a water jacket that is disposed around a portion of the engine, such that water within the water jacket becomes vapor in response to heat being received by the water jacket.

18. The system of claim 15, wherein the vapor device includes a tank that contains water, the tank configured to receive the exhaust gases from the main combustion chamber and to generate vapor in response to the heat from the exhaust gasses.

19. The system of claim 15, wherein the vapor device is configured to circulate the vapor to a turbine such that the turbine is driven by the vapor to drive intake of the air delivered to the main combustion chamber.

20. The system of claim 15, wherein the water vapor device is configured to cool at least one of the crown or the head by generating the vapor.
